(19) United States
(12) Patent Application Publication
(10) Pub. No.: US 2007/0019515 A1
(43) Pub. Date: Jan. 25, 2007

(54) Optical writing device, optical writing method, and image forming apparatus

(76) Inventor: Nobuyoshi Kaima, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/490,076

(22) Filed: Jul. 21, 2006

(30) Foreign Application Priority Data
Oct. 31, 2005 (JP) 2005-317019
Jul. 21, 2005 (JP) 2005-211659

(51) Int. Cl. G11B 7/00

(52) U.S. Cl. 369/44.23

(57) ABSTRACT

A device, apparatus, method, computer program and product, each capable of controlling the intensity or duration of a light beam in a detection area of an optical writing device. The intensity of the light beam is one value when irradiating a detector, and a different value when irradiating an image writing portion of a photosensitive area.

### CROSS-REFERENCE TO RELATED APPLICATIONS

This patent application is based on and claims priority to Japanese patent application Nos. 2005-211659 filed on Jul. 21, 2005, and 2005-317019 filed on Oct. 31, 2005, in the Japanese Patent Office, the entire contents of which are hereby incorporated by reference.

### FIELD OF THE INVENTION

The following disclosure relates generally to a device, apparatus, method, system, computer program and product, each capable of controlling the intensity or duration of a light beam for image formation.

### DESCRIPTION OF THE RELATED ART

In a background image forming apparatus, an optical writing device is provided which scans a light beam to form a plurality of light spots on an image writing area of the optical writing device in order to form a latent image on the image writing area.

To improve image quality, the scanning process performed by the optical writing device may need to be controlled based on various image forming conditions, for example, including environmental or temporal factors, characteristics of the optical writing device or the image forming apparatus, or modes of operation. In one example, the intensity or duration of the light beam may be detected and used to adjust a start position of image recording as described in the U.S. Pat. No. 6,847,390, patented on Jan. 25, 2005. In another example, the unevenness in density in the sub-scanning direction may be corrected using the light intensity of the light beams as described in the JP Patent Application Publication No. 2005-007697, published on Jan. 13, 2005.

### BRIEF SUMMARY OF THE INVENTION

According to the U.S. Pat. No. 6,847,390 or the JP Patent Application Publication No. 2005-007697, the intensity or duration of the light beam irradiated to the image writing area is controlled using a detector, which detects the light beam entering a detection area, i.e., the outside of the image writing area of the optical writing device. Thus, to properly adjust the intensity or duration of the light beam in the image writing area, the light beam in the detection area needs to be detected with high accuracy by the detector.

The following disclosure describes exemplary embodiments of a device, apparatus, method, computer program and product, each capable of controlling the intensity or duration of the light beam in the detection area of the optical writing device.

In one example, the detection area includes a first detection area to which the light beam enters before it enters the image writing area. The light beam entering the first detection area of the optical writing device is caused to have a first fixed intensity, while the light beam entering the image writing area of the optical writing device is caused to have a varied intensity.

In another example, the detection area includes the first detection area, and a second detection area to which the light beam enters after it passes the image writing area. The light beam entering the first detection area of the optical writing device is caused to have the first fixed intensity. The light beam entering the image writing area of the optical writing device is caused to have the varied intensity. The light beam entering the second detection area of the optical writing device is caused to have a second fixed intensity.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic block diagram illustrating the structure of an optical writing device according to an example embodiment of the present invention;

FIG. 2 is a cross-section diagram illustrating the structure of an image forming apparatus incorporating the optical writing device of FIG. 1 according to an example embodiment of the present invention;

FIG. 3 is a schematic block diagram illustrating the structure of a portion of the image forming apparatus of FIG. 2;

FIG. 4 is a schematic block diagram illustrating the structure of a laser diode (LD) controller of FIG. 1;

FIG. 5 is a timing chart illustrating operation of controlling the intensity of a light beam according to an example embodiment of the present invention;

FIG. 6 is a table illustrating the correspondence between a light beam intensity and an operation mode according to an example embodiment of the present invention;

FIG. 7 is a table illustrating the correspondence between a table identification number and a default value of a reference voltage according to an example embodiment of the present invention;

FIG. 8 is a timing chart illustrating operation of controlling the intensity of a light beam according to an example embodiment of the present invention;

FIG. 9 is a timing chart illustrating operation of controlling the intensity of a light beam when detecting a detection signal according to an example embodiment of the present invention;

FIG. 10 is a timing chart illustrating operation of controlling the intensity of a light beam according to an example embodiment of the present invention;

FIG. 11 is a timing chart illustrating operation of controlling the intensity of a light beam according to an example embodiment of the present invention;

FIG. 12 is a timing chart illustrating operation of obtaining a detection signal according to an example embodiment of the present invention;

FIG. 13 is a timing chart illustrating operation of obtaining a detection signal according to an example embodiment of the present invention; and

FIG. 14 is a cross-section diagram illustrating a portion of the structure of an image forming apparatus incorporating the optical writing device of FIG. 1 according to an example embodiment of the present invention.

### DETAILED DESCRIPTION OF THE INVENTION

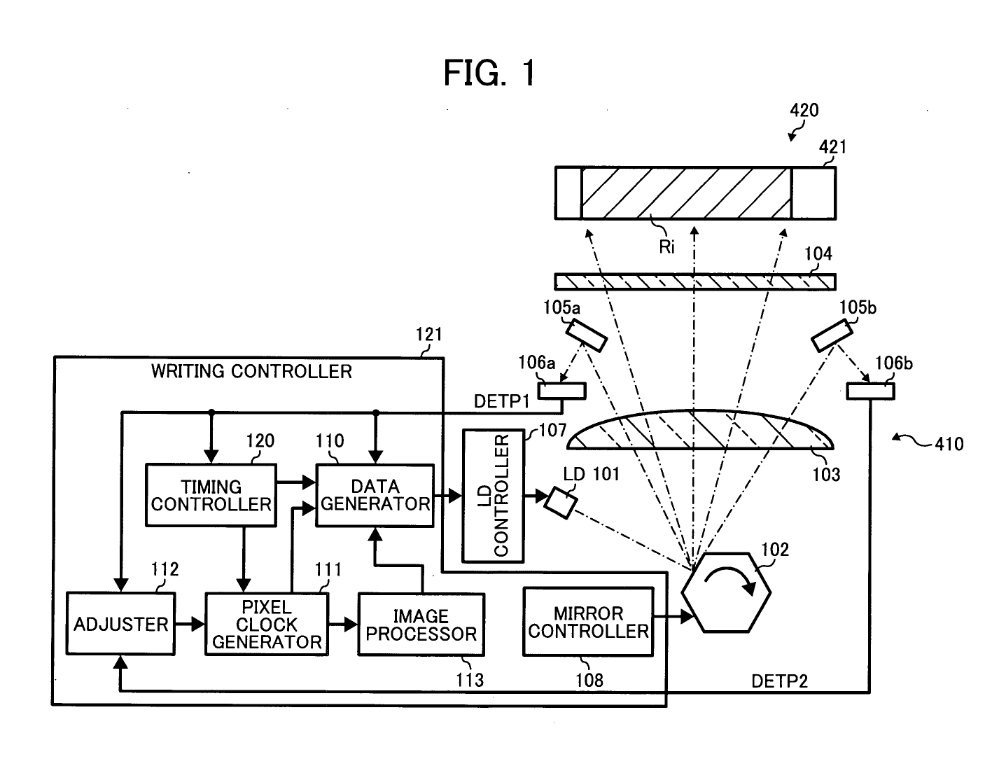

In describing the example embodiments illustrated in the drawings, specific terminology is employed for clarity. However, the disclosure of this patent specification is not intended to be limited to the specific terminology selected and it is to be understood that each specific element includes all technical equivalents that operate in a similar manner. Referring now to the drawings, wherein like reference numerals designate identical or corresponding parts throughout the several views, FIG. 1 illustrates an optical writing device 410 according to an example embodiment of the present invention.

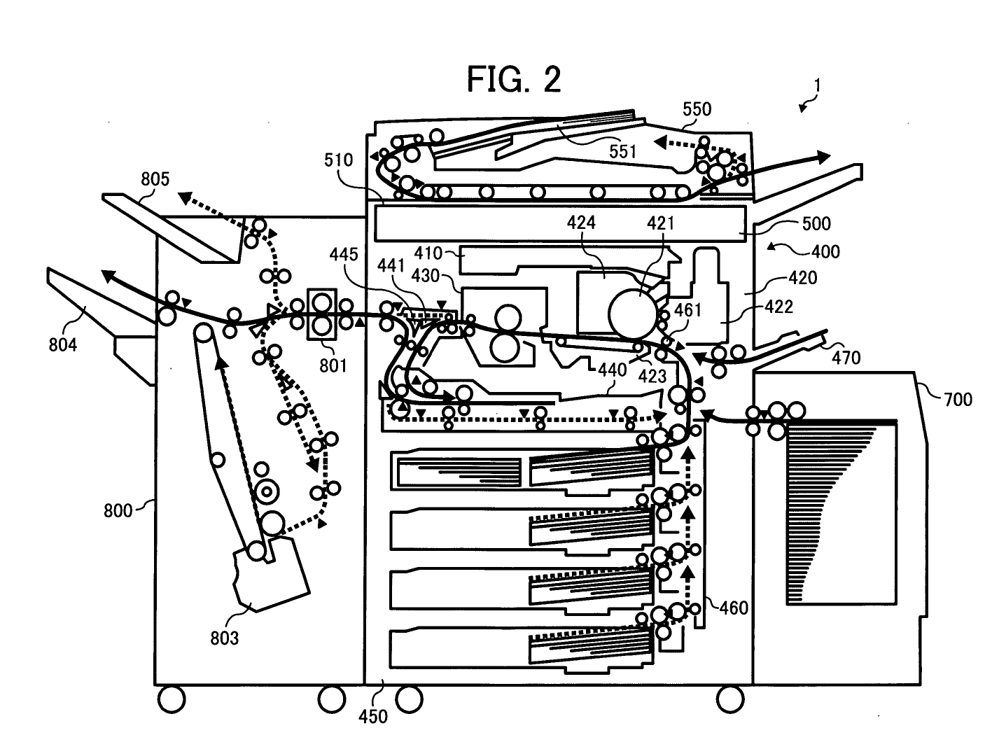

The optical writing device 410 is capable of scanning a light beam onto a surface of an image carrier. In this example, the optical writing device 410 is incorporated in an image forming apparatus 1 shown in FIG. 2 to form a latent image on a photoconductor 421 of an image forming device 420.

Referring to FIG. 1, the optical writing device 410 includes a laser diode (LD) 101, a polygon mirror 102, a f-theta lens 103, a protector 104, a first reflective mirror 105a, a second reflective mirror 105b, a first detector 106a, a second detector 106b, a LD controller 107, a mirror controller 108, a data generator 110, a pixel clock generator 111, an adjuster 112, an image processor 113, and a timing controller 120. In this example, the timing controller 120, data generator 110, adjuster 112, pixel clock generator 111, image processor 113, and mirror controller 108 are collectively referred to as a writing controller 121. The elements of the optical writing device 410 are exemplary and elements can be removed or added from the optical writing device, as desired.

In operation, the laser diode 101 irradiates a light beam onto a surface of the polygon mirror 102, which rotates in the clockwise direction under control of the mirror controller 108. With the rotation of the polygon mirror 102, the light beam is scanned in the main scanning direction (i.e., from left to right in FIG. 1) with a constant angular velocity, toward the f-theta lens 103. As the light beam passes the f-theta lens 103, the light beam is deflected so as to scan a surface of the photoconductor 421 with a constant scanning speed to form a plurality of light spots in the main scanning direction. As the photoconductor 421 rotates in the sub-scanning direction, the light beam subsequently illuminates a downstream surface of the photoconductor 421. In this example, the plurality of light spots is formed in an image writing area of the optical writing device 410, which is indicated by “Ri” in FIG. 1. The protector 104, which is located between the f-theta lens 103 and the photoconductor 421, protects the photoconductor 421 from foreign matter, such as dust, to suppress degradation of the latent image.

Still referring to FIG. 1, the first reflective mirror 105a, second reflective mirror 105b, first detector 106a, and second detector 106b are each provided in a detection area of the optical writing device 410, which is outside of the image writing area Ri. Before reaching the image writing area Ri, the light beam, which is irradiated from the polygon mirror 102, is reflected from the first reflective mirror 105a toward the first detector 106a. Upon receiving the light beam, the first detector 106a outputs a start detection signal DETP1 to the writing controller 121. Similarly, after scanning through the image writing area Ri, the light beam is reflected from the second reflective mirror 105b toward the second detector 106b. Upon receiving the light beam, the second detector 106b outputs an end detection signal DETP2 to the writing controller 121. The mirrors 105a and 105b are optional and may be omitted, as long as the detectors 106a and 106b are positioned to receive the light. Alternatively, more than one mirror may be used to reflect the light to the corresponding detector.

Referring now to FIG. 2, an example structure and operation of the image forming apparatus 1 are explained. As illustrated in FIG. 2, the image forming apparatus 1 includes a printer 400, an image reader 500, an automatic document feeder (ADF) 550, a sheet storage section or device 700, and a finisher 800.

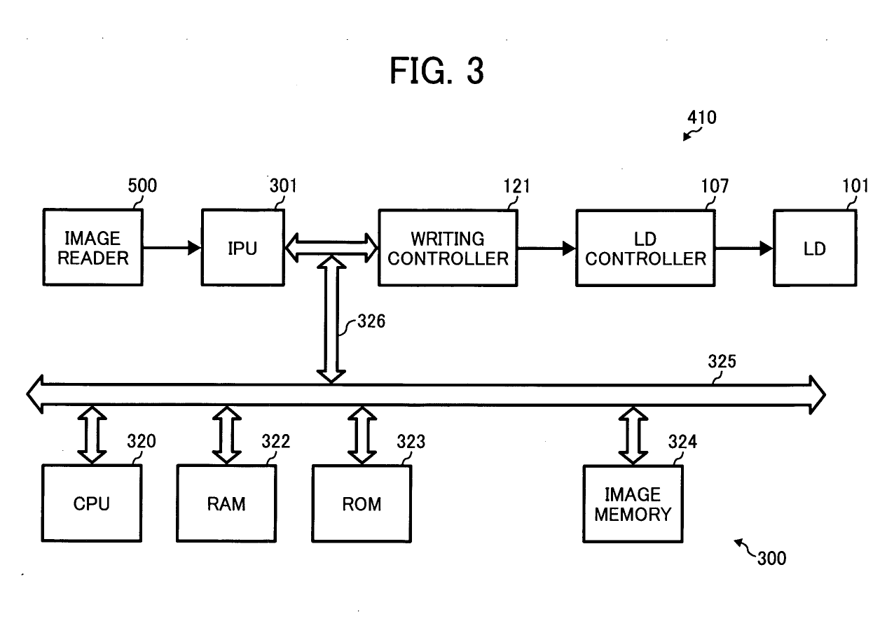

The ADF 550 feeds an original document, which is placed on a document tray 551 toward an exposure glass 510 as indicated by an arrow shown in FIG. 2. The image reader 500, which is mounted on the printer 400, reads the original document, which may be fed by the ADF 550 or may be placed on the exposure glass 510, into image data using a photoelectric converter, for example, a charged coupled device (CCD). The image reader 500 stores the image data in a memory after performing any desired image processing to the image data using an image processing unit (IPU) 301 shown in FIG. 3. The sheet storage 700, which is located at one side of the printer 400, stores a large amount of recording sheets. The finisher 800, which is located at one side of the printer 400, includes a puncher 801, a stapler 803, output trays 804 and 805, and other devices.

The printer 400 includes the optical writing device 410, the image forming device 420, a fixing device 430, a sheet path switch device 440, sheet cassettes 450, a vertical sheet feeder 460, and a manual sheet tray 470. The optical writing device 410, which is shown in FIG. 1, irradiates a light beam according to the image data to form a latent image on the photoconductor 421. The image forming device 420 includes the photoconductor 421, a developer 422, a transfer device 423, a cleaning device 424, and other devices. The image forming device 420 develops the latent image formed on the photoconductor 421 into a toner image using toner supplied from the developer 422, and transfers the toner image onto a recording sheet carried by the transfer device 423. The recording sheet may be fed from the manual sheet tray 470 through registration rollers 461. Alternatively, the recording sheet may be fed from the sheet storage 700 or the sheet cassettes 450, through the vertical sheet feeder 460 and the registration rollers 461. The fixing device 430 fixes the toner image onto the recording sheet, while the recording sheet passes through a nip formed between two rollers of the fixing device 430. The sheet path switch device 440 may transfer the recording sheet, which is received from the fixing device 430, either toward the transfer device 423 or toward the finisher 800, using pawls 441 and 445. The recording sheet having the toner image thereon may be output onto the output tray 804 or 805.

Further, as illustrated in FIG. 3, the image forming apparatus 1 includes a controller 300, which controls operation of the image forming apparatus 1. Referring to FIG. 3, the controller 300 includes a central processing unit (CPU) 320, a random access memory (RAM) 322, a read only memory (ROM) 323, and an image memory 324, which are connected via a system bus 325. The controller of FIG. 3 is connected to other devices, for example, to the image reader 500, the IPU 301 or the optical writing device 410, through an interface 326. The CPU 320 may be implemented by any desired processor. The RAM 322 may function as a work memory for the CPU 320. The ROM 323 may store various data, for example, a light controlling program of the present invention, or one or more tables that may be used by the CPU 320 for controlling the optical writing device 410. The image memory 324 stores image data, which may be read by the image reader 500.

In an example operation, as illustrated in FIG. 3, the image reader 500 reads the original document into image data, and applies various image processing to the image data using the IPU 301. The processed image data is stored in the image memory 324, for example, in a compressed format. When the CPU 320 receives an instruction for printing the image data, the CPU 320 reads out the image data from the image memory 324, decompresses the image data, and sends the decompressed image data to the writing controller 121 through the interface 326. The writing controller 121 generates an image data signal from the image data. The LD controller 107 drives the LD 101 to form a latent image on the photoconductor 421 according to the image data signal under control of the CPU 320. The latent image is developed into a toner image using the developer 422 of FIG. 2. The toner image is then transferred to a recording sheet. The recording sheet having the toner image thereon is transferred and output onto the output tray 804 or 805 of FIG. 2.

As described above, to improve image quality, the intensity or duration of the light beam to be irradiated from the LD 101 may need to be adjusted depending on various image forming conditions, including environmental factors such as temperature or humidity, temporal factors such as the usage amount of the photoconductor 421, characteristics of the optical writing device 410 such as the characteristics of the f-theta lens 103 or the fluctuations in rotation of the polygon mirror 102, etc.

In one example, referring to FIG. 1, the number of light spots or position of light spots formed on the image writing area Ri may be adjusted using the adjuster 112 and the pixel clock generator 111, in a substantially similar manner as described in the US Patent Application Publication No. 20030067533, published on Apr. 10, 2003, the entire contents of which are hereby incorporated by reference. For example, the adjuster 112 counts a scan time period Nc using the start detection signal DETP1 and the end detection signal DETP2, and compares the counted scan time period Nc with a reference scan time period No to generate phase data that indicates the number or position of light spots to be adjusted. The pixel clock generator 111 adjusts a pixel clock signal PCLK based on the phase data, and outputs the adjusted pixel clock signal PCLK.

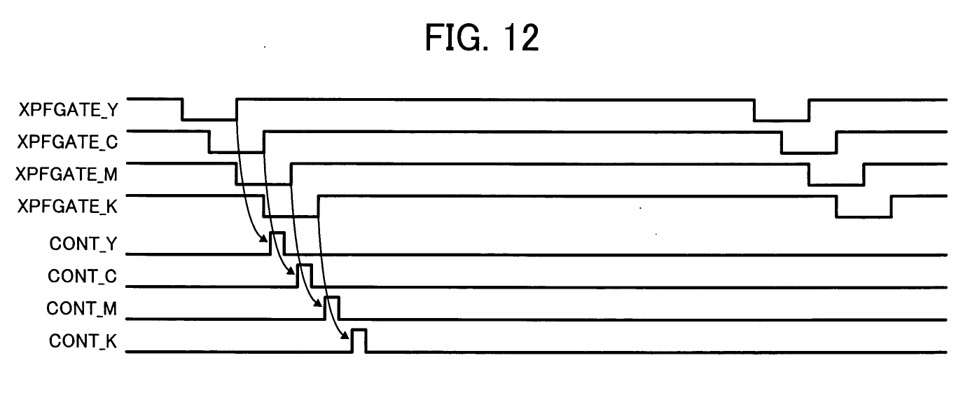

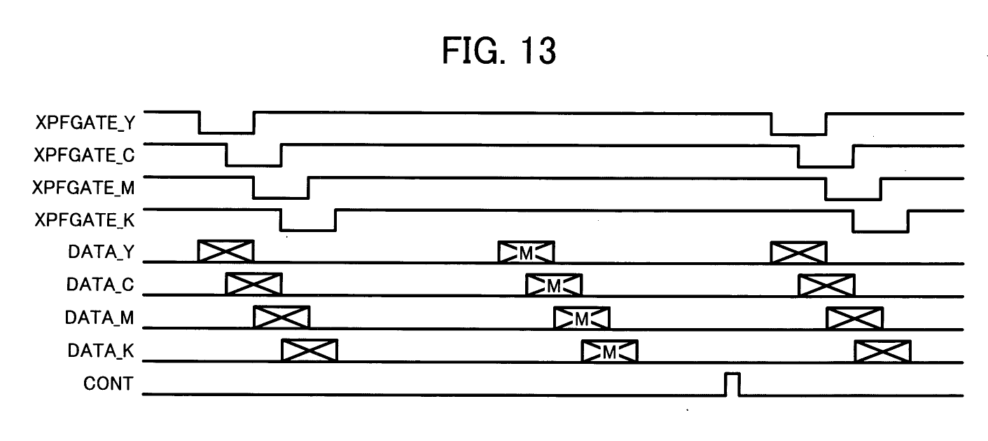

In another example, the adjuster 112 counts a scan time period Nc using the start detection signal DETP1 and the end detection signal DETP2, and compares the counted scan time period Nc with a reference scan time period No to generate a difference scan time period, for example, No/Nc. The adjuster 112 outputs the difference scan time period No/Nc to the pixel clock generator 111. In this example, the reference scan time period No may be obtained at a predetermined timing, for example, at the timing when the image forming apparatus 1 is shipped, and stored in the ROM 323. The pixel clock generator 111 outputs a pixel clock signal PCLK, which is synchronized with the detection signal DETP1 or DETP2. For example, the pixel clock generator 111 may obtain a frequency Fp of the pixel clock signal PCLK, by multiplying the difference scan time period No/Nc with a reference frequency Fr of the pixel clock signal PCLK. The pixel clock generator 111 outputs the pixel clock signal PCLK having the obtained frequency Fp. In this example, the reference frequency Fr may be obtained from a reference clock generator, which may be provided in the pixel clock generator 111. Alternatively, the reference frequency Fr may correspond to the frequency of the pixel clock signal PCLK when the start detection signal DETP1 or the end detection signal DETP2 is output. In this example, the counted scan time period Nc may be obtained as a difference between the start detection signal DETP1 and the end detection signal DETP2, preferably, at a predetermined timing described below referring to FIGS. 12 and 13. The adjuster 112 may be implemented using a programmed processor, hardware, or a combination of hardware and software.

As described above, the number or position of the light spots in the main scanning direction may be properly adjusted using the start detection signal DETP1 or the end detection signal DETP2 for improved image quality.

Referring back to FIG. 1, the timing controller 120 may be provided with a counter, which counts a timing period in the main scanning direction or in the sub-scanning direction. For example, to control a timing for starting image writing, the timing controller 120 counts a time period from the timing when the start detection signal DETP1 is output from the first detector 106a, and outputs an image writing start signal to the data generator 110 and the pixel clock generator 111 when the counted time period reaches a reference time period. The reference time period is previously set so as to correspond to a timing when the light beam enters the image writing area Ri.

The image processor 113 outputs an image data signal, which corresponds to the image data obtained from the image memory 324 of FIG. 3, in synchronization with the pixel clock signal PCLK received from the pixel clock generator 111. The data generator 110 modulates the image data signal using the pixel clock signal PCLK to generate a modulated image data signal VDATA, and outputs the modulated image data signal VDATA at a timing determined by the image writing start signal to the LD controller 107. The LD controller 107 controls the duration of the light beam, by turning on or off the LD 101 according to the modulated image data signal VDATA received from the data generator 110. Further, the LD controller 107 controls the intensity of the light beam of the LD 101 under control of the CPU 320.

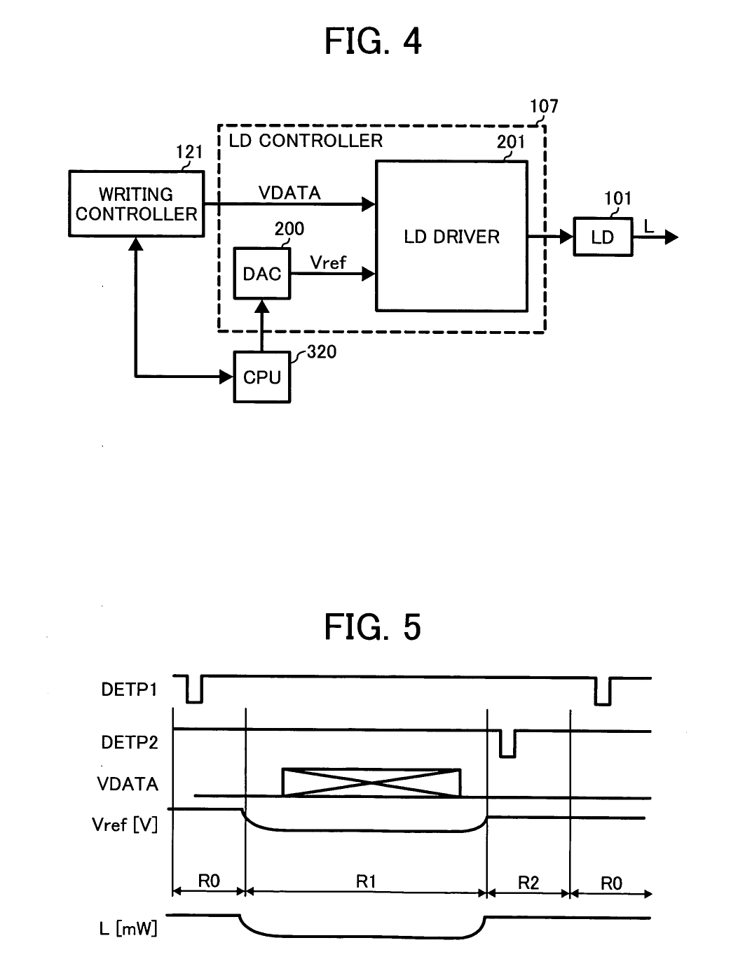

As illustrated in FIG. 4, the LD controller 107 includes a digital analog converter (DAC) 200 and an LD driver 201. The LD driver 201 turns on or off the LD 101 according to the modulated image data signal VDATA, which is received from the data generator 110 of the writing controller 121. The LD driver 201 causes the LD 101 to irradiate the light beam having a light intensity L, which is determined by a reference voltage Vref output from the DAC 200. In this example, the DAC 200 converts the reference voltage Vref, which is set by the CPU 320, from digital to analog.

As illustrated in FIG. 5, the CPU 320 sets a fixed level of the reference voltage Vref when the light beam irradiates the detection area of the optical writing device 410. The CPU 320 sets a varied level of the reference voltage Vref when the light beam irradiates the image writing area of the optical writing device 410. In this example, the first detection area R0 corresponds to a detection area where the first detector 106a is provided, which outputs the start detection signal DETP1. The second detection area R2 corresponds to a detection area where the second detector 106b is provided, which outputs the end detection signal DETP2. The image writing area in which the latent image is formed according to the modulated image data signal VDATA is indicated by R1. Information indicating the area to which the light beam currently irradiates may be obtained from the timing controller 120 of the writing controller 121. Further, as illustrated in FIG. 5, the light intensity L of the LD 101 increases proportionally to the level of the reference voltage Vref.

Still referring to FIG. 5, an example operation of controlling the intensity of the light beam, performed by the CPU 320, is explained. In this example, the default value of the reference voltage Vref is previously set depending on the characteristics of the optical writing device 410. For example, the default value of the reference voltage Vref may be set according to the resistance value at the timing when the image forming apparatus 1 is shipped. Further, the default value of a scanning speed S is previously set depending on the characteristics of the optical writing device 410. When the CPU 320 performs the scanning operation with the default value of the reference voltage Vref and the default value of the scanning speed S, the LD driver 201 causes the LD 101 to output the default value of the light intensity L. For example, if the default value of the reference voltage Vref is set to 128 decimal (dec), the LD 101 outputs the default value of the light intensity L, which is 0.128 mW. The decimal value of Vref may correspond to the digital input to the DAC 200 in a decimal representation. Alternatively, Vref may be represented as an appropriate analog value output from the DAC 200.

The light intensity L may be adjusted depending on the area to which the light beam L currently irradiates.

When the light beam L irradiates the image writing area R1, the value of the reference voltage Vref is adjusted using the ratio of the actual value of the scanning speed S relative to the default value of the scanning speed S, as described in the following equation:

Vref1=Vrefd*Sa/Sd, wherein Vref1 corresponds to the adjusted value of the reference voltage Vref for the image writing area R1, Vrefd corresponds to the default value of the reference voltage Vref, Sa corresponds to the actual value of the scanning speed S, and Sd corresponds to the default value of the scanning speed S. In this example, the actual value of the scanning speed S may be obtained by the CPU 320 based on the start and end detection signals DETP1 and DETP2. The value of the reference voltage Vref may be expressed in the digital format, for example, in decimal (dec) or hexadecimal (h). The value of the scanning speed S may be expressed in mm/s.

If the default value Vrefd of the reference voltage Vref is set to 128 dec, the above-described equation may be expressed as:
Vref1=128(dec)*Sa(mm/s)/Sd(mm/s).

Since the default value of the light intensity L is set to 0.128 mW, and the light intensity L increases proportionally to the reference voltage Vref, the value of the light intensity L for the image writing area R1 may be obtained using the following equation:
L1=0.128(mW)*Sa/Sd.

Accordingly, the intensity of the light beam for the image writing area R1 varies depending on the actual scanning speed S, i.e., the counted scan time period obtained from the start detection signal DETP1 and the end detection signal DETP2.

When the light beam L irradiates the first detection area R0, the value of the reference voltage Vref is adjusted based on a first fixed value X as described in the following equation:

Vref0=Vrefd*X, wherein Vref0 corresponds to the adjusted value of the reference voltage Vref for the first detection area R0. In this example, the first fixed value X is previously set depending on the characteristics of the optical writing device 410. If the default value Vrefd of the reference voltage Vref is set to 128 dec, and the first fixed value X is set to 1.2, the above-described equation may be expressed as:
Vref0=128(dec)*1.2.

Since the default value of the light intensity L is set to 0.128 mW, and the light intensity L increases proportionally to the reference voltage Vref, the value of the light intensity L for the first detection area R0 may be obtained using the following equation:
L0=0.128(mW)*1.2.

Accordingly, the intensity of the light beam for the first detection area R0 is fixed, which may increase the detection accuracy of the start detection signal DETP1.

When the light beam L irradiates the second detection area R2, the value of the reference voltage Vref is adjusted based on a second fixed value Y as described in the following equation:

Vref2=Vrefd*Y, wherein Vref2 corresponds to the adjusted value of the reference voltage Vref for the second detection area R2. In this example, the second fixed value Y is previously set depending on the characteristics of the optical writing device 410. If the default value Vrefd of the reference voltage Vref is set to 128 dec, and the second fixed value Y is set to 1.2, the above-described equation may be expressed as:
Vref2=128(dec)*1.2.

Since the default value of the light intensity L is set to 0.128 mW, and the light intensity L increases proportionally to the reference voltage Vref, the value of the light intensity L for the second detection area R2 may be obtained using the following equation:
L2=0.128(mW)*1.2.

Accordingly, the intensity of the light beam for the second detection area R2 is fixed, which may increase the detection accuracy of the end detection signal DETP2. As described above, in order to further increase the detection accuracy, the first fixed value X and the second fixed value Y may be set equal. However, the optical characteristics of the first detector 106a and the second detector 106b may need to be considered.

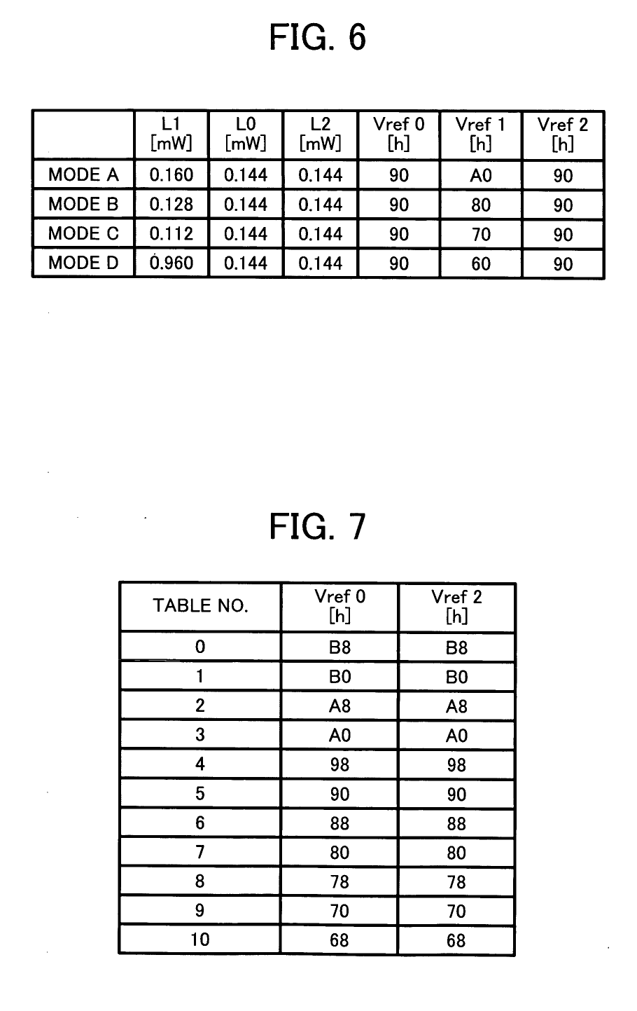

Referring now to FIG. 6, an example operation of controlling the intensity of the light beam, performed by the CPU 320, is explained. In this example, the ROM 323 of FIG. 3 stores a set table shown in FIG. 6, which stores a set of values including the light intensity values L0, L1, and L2, and the reference voltage values Vref0, Vref1, and Vref2, for each of operation modes A, B, C, and D. The CPU 320 may select one of the operation modes A, B, C, and D depending on various image forming conditions, for example, a desired scanning speed, or the characteristics of the photoconductor 421 that may change over time. Alternatively, the CPU 320 may select one of the operation modes A, B, C, and D according to the user preference, which may be input, for example, through an operation control panel that may be provided in the image forming apparatus 1.

As illustrated in FIG. 6, the light intensity L1 for the image writing area R1 varies depending on the operation mode, while the light intensity L0 or L2 for the detection area R0 or R2 remains constant. For example, if the operation mode is changed from the mode B to the mode C, the CPU 320 changes the reference voltage value Vref1 from 80 h to 70 h, which causes the light intensity L1 to change from 0.128 mW to 0.112 mW, when the light beam is irradiated to the image writing area R1. When the light beam is irradiated to the detection area R0 or R2, the reference voltage value Vref remains constant. For example, the reference voltage value Vref0 or Vref2 may be set to be equal to a default value Vrefd, which differs depending on the characteristics of the optical writing device 410.

In this example, the ROM 323 of FIG. 3 may store a plurality of set tables, each set table storing a set of light intensity values and reference voltage values for a specific default value of the reference voltage. Each set table is assigned with a table identification number, for example, 0, 1, 2, etc. In addition, the ROM 323 of FIG. 3 may store a table shown in FIG. 7, which lists the table identification number and the default reference voltage value in a corresponding manner. For example, if the CPU 320 sets the default value of the reference voltage Vref to be 90 h, the set table assigned with the table identification number of 5 is selected using the table shown in FIG. 7. This table with identification number 5 corresponds, for example, to the table shown in FIG. 6 as the table of FIG. 6 has Vref0 and Vref2 equal to 90 h. Using information stored in the set table having the table identification number of 5, the CPU 320 may control the light intensity L of the LD 101.

Referring to FIG. 5, the CPU 320 classifies the area to which the light beam is irradiated into three areas R0, R1, and R2 in the main scanning direction. However, the area to which the light beam is irradiated may be classified into more than three areas in the main scanning direction.

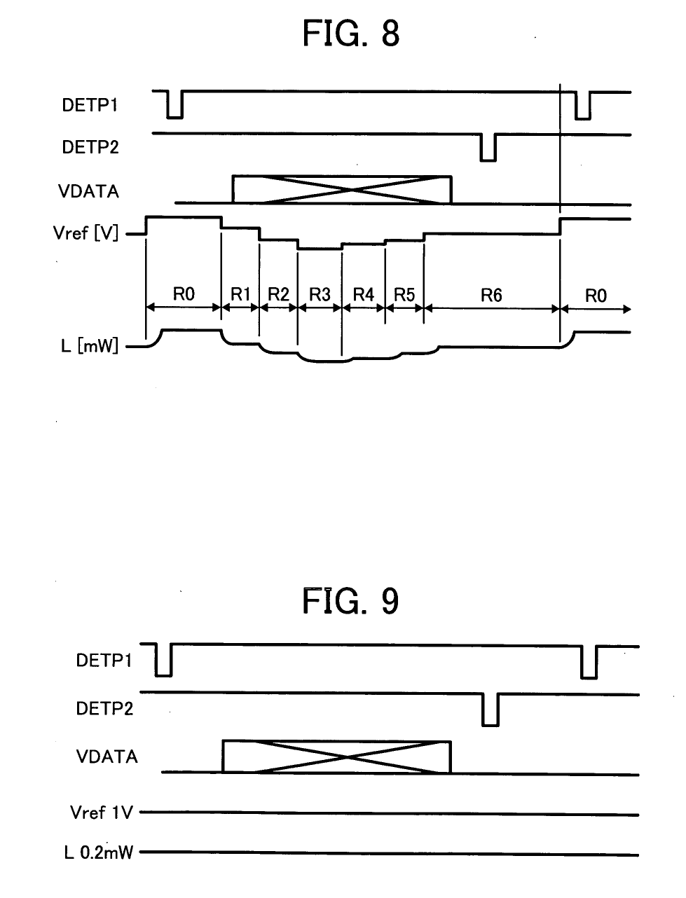

Referring now to FIG. 8, an example operation of controlling the intensity of the light beam, performed by the CPU 320, is explained. In this example, the CPU 320 sets a fixed level of the reference voltage Vref when the light beam irradiates the first detection area R0, which corresponds to a detection area where the first detector 106a for outputting the start detection signal DETP 1 is provided. The CPU 320 sets a varied level of the reference voltage Vref when the light beam irradiates the image writing area R1, R2, R3, R4, or R5. The CPU 320 continues to set a varied level of the reference voltage Vref when the light beam irradiates the area R6, which includes the end portion of the image writing area and the second detection area where the second detector 106b for outputting the end detection signal DETP 2 is provided. For example, when the light beam is irradiated to the areas R1, R2, R3, R4, R5, or R6, the CPU 320 causes the LD controller 107 to perform shading correction. When the shading correction is performed, the intensity of the light beam is adjusted depending on the optical characteristics of the optical writing device 410, for example, by changing the value of the reference voltage Vref. As shown in FIG. 8, the intensity of the light beam changes proportionally to the value of the reference voltage Vref.

Referring to FIG. 8, since the intensity of the light beam for the detection area R0 is fixed, the detection accuracy of the start detection signal DETP1 may increase. In addition to the increased detection accuracy in the start detection signal DETP1, the detection accuracy of the end detection signal DETP2 may increase by turning off the shading correction function at the time of detecting the end detection signal DETP2.

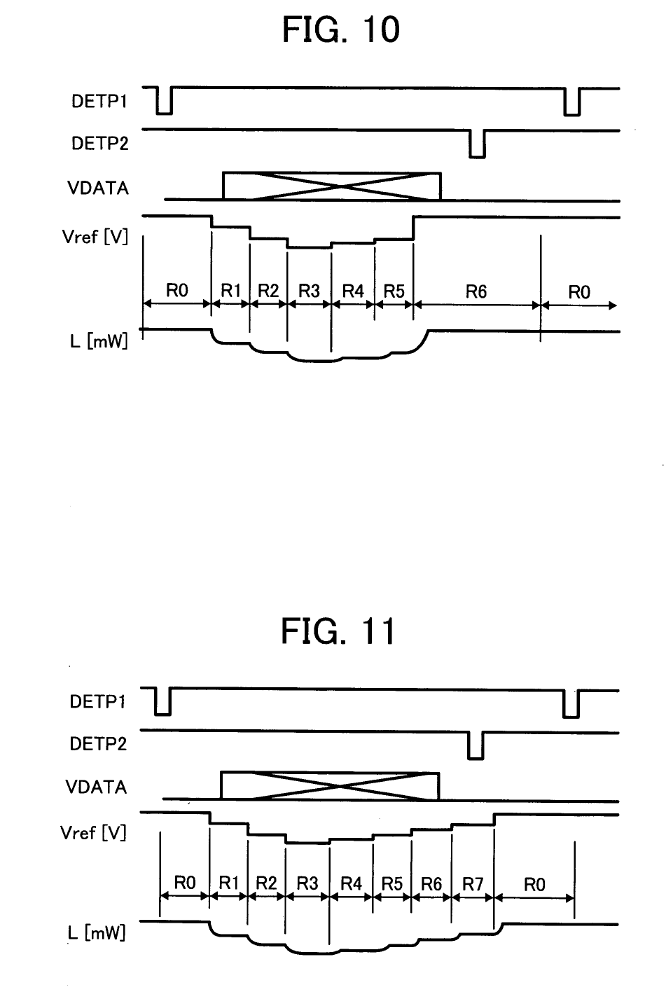

For example, as illustrated in FIG. 9, when the timing controller 120 of FIG. 1 indicates that the light beam enters the area R6 of FIG. 8, the CPU 320 causes the LD controller 107 to turn off the shading correction function, and sets the reference voltage Vref to be equal to the value of the reference voltage Vref for the first detection area R0. In this example, the reference voltage Vref is set to 1 V. The light intensity L of 0.2 mW is irradiated to the LD 101 toward the rear end of the image writing area and the second detection area. When the light beam irradiates the second detector 106b, the second detector 106b outputs the end detection signal DETP 2 to the writing controller 121. Since the start detection signal DETP1 and the end detection signal DETP2 are detected using the same light intensity L as illustrated in FIG. 10, the scan time period, which is the difference between the start and end detection signals DETP1 and DETP2, may be obtained with high accuracy.

Referring now to FIG. 11, an example operation of controlling the intensity of the light beam, performed by the CPU 320, is explained. In this example, when the light beam irradiates the first detection area R0, the CPU 320 sets a first fixed level of the reference voltage Vref depending on the optical characteristics of the first detector 106a. The CPU 320 sets a varied level of the reference voltage Vref when the light beam irradiates the image writing area R1, R2, R3, R4, R5, or R6. When the light beam irradiates the second detection area R7 where the second detector 106b for outputting the end detection signal DETP2 is provided, the CPU 320 sets a second fixed level of the reference voltage Vref depending on the optical characteristics of the second detector 106b. In this manner, the fixed level of the reference voltage Vref may be properly set for each of the detectors, depending on the characteristics of the detector, such as its sensitivity.

For any one of the above-described examples, the counted scan time period may be obtained at a predetermined timing. The predetermined timing may be set to a timing before the image forming apparatus 1 performs image formation, a timing after the image forming apparatus 1 is instructed to perform image formation, a timing after the image forming apparatus 1 completes initial setting for image formation, or a timing occurred after the image forming apparatus 1 performs image formation on a preceding recording sheet or before the image forming apparatus 1 performs image formation on a following recording sheet. After the counted scan time period is obtained, the image forming apparatus 1 may perform image processing, such as magnification correction, based on the obtained scan time period. In this manner, the resultant image quality may increase.

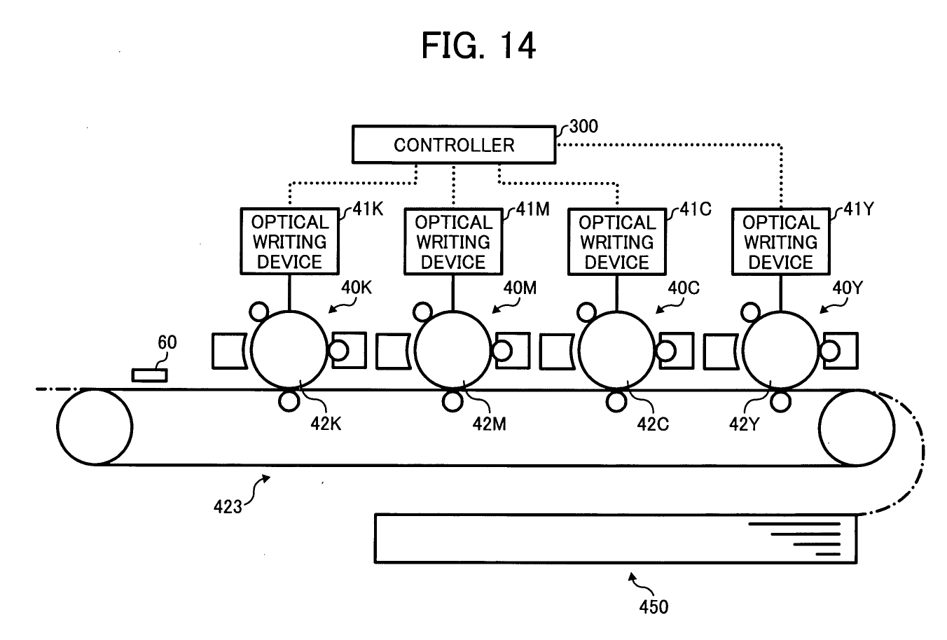

Referring now to FIGS. 12 and 13, example operations of obtaining a counted scan time period from the start and end detection signals DETP1 and DETP2 are explained. In this example, the counted scan time period is obtained for a color image forming apparatus including optical writing devices 41Y, 41C, 41M, and 41K, shown in FIG. 14. The color image forming apparatus of FIG. 14 is substantially similar in structure to the image forming apparatus 1 of FIG. 2. The differences include the replacement of the optical writing device 410 with the optical writing devices 41Y, 41C, 41M, and 41K, the replacement of the image forming device 420 with image forming devices 42Y, 42C, 42M, and 42K, and the addition of a pattern detector 60. The optical writing devices 41Y, 41C, 41M, and 41K each have the structure shown in FIG. 1. In this example, Y, C, M, and K respectively correspond to the yellow color, cyan color, the magenta color, and black color. The optical writing device 41Y forms a latent image for the yellow color on a photoconductor 42Y of the image forming device 40Y. The optical writing device 41C forms a latent image for the cyan color on a photoconductor 42C of the image forming device 40C. The optical wiring device 41M forms a latent image for the magenta color on a photoconductor 42M of the image forming device 40M. The optical writing device 42K forms a latent image for the black color on a photoconductor 42K of the image forming device 40K.

In one example, referring to FIG. 12, upon receiving an instruction for starting image formation from the CPU 320, the timing controller 120 of each of the optical writing devices 41Y, 41C, 41M, and 41K outputs an image writing start signal for each of the colors K, C, M, and Y to the LD controller 107. As shown in FIG. 12, the timing controller 120 of the optical writing device 41Y outputs the image start writing signal XPFGATE_Y to cause the LD 101 to form a latent image for the yellow color. The timing controller 120 of the optical writing device 41C outputs the image start writing signal XPFGATE_C to cause the LD 101 to form a latent image for the cyan color. The timing controller 120 of the optical writing device 41M outputs the image start writing signal XPFGATE_M to cause the LD 101 to form a latent image for the magenta color. The timing controller 120 of the optical writing device 41K outputs the image writing start signal XPFGATE_K to cause the LD 101 to form a latent image for the black color.

The CPU 320 instructs the adjuster 112 of each of the optical writing devices 41Y, 41C, 41M, and 41K to obtain the counted scan time period for each of the colors at a timing determined by each of the image writing start signals. As illustrated in FIG. 12, the adjuster 112 of the optical writing device 41Y obtains the scan time period for the yellow color, using the start detection signal DETP1 and the end detection signal DETP2 at a timing indicated by CONT_Y. The adjuster 112 of the optical writing device 41C obtains the scan time period for the cyan color, using the start detection signal DETP1 and the end detection signal DETP2 at a timing indicated by CONT_C. The adjuster 112 of the optical writing device 41M obtains the scan time period for the magenta color, using the start detection signal DETP1 and the end detection signal DETP2 at a timing indicated by CONT_M. The adjuster 112 of the optical writing device 41K obtains the scan time period for the black color, using the start detection signal DETP1 and the end detection signal DETP2 at a timing indicated by CONT_K.

In another example, referring to FIG. 13, upon receiving an instruction for starting image formation from the CPU 320, the timing controller 120 of each of the optical writing devices 41Y, 41C, 41M, and 41K outputs an image writing start signal for each of the colors Y, C, M, and K to the LD controller 107. The LD controller 107 outputs a modulated image data signal for each of the colors Y, C, M, and K to cause the LD 101 to form a latent image for each of the colors Y, C, M, and K. As shown in FIG. 13, the timing controller 120 of the optical writing device 41Y outputs the image start writing signal XPFGATE_Y. At the substantially same timing, the LD controller 107 outputs the image data signal DATA_Y. The timing controller 120 of the optical writing device 41C outputs the image start writing signal XPFGATE_C. At the substantially same timing, the LD controller 107 outputs the image data signal DATA_C. The timing controller 120 of the optical writing device 41M outputs the image start writing signal XPFGATE_M. At the substantially same timing, the LD controller 107 outputs the image data signal DATA_M. The timing controller 120 of the optical writing device 41K outputs the image start writing signal XPFGATE_K. At the substantially same timing, the LD controller 107 outputs the image data signal DATA_K. In this example, after the timing when the image start writing signal XPFGATE_K is output, the LD controller 107 of each of the optical writing devices 41Y, 41C, 41M, and 41K outputs a pattern signal (indicated by “M” in FIG. 13) to form a pattern on the surface of a transfer belt of the transfer device 423 (FIG. 14). Each of the patterns is detected by the pattern detector 60, and is used to adjust the position of the light spots in the main scanning direction, for example, as described in the US Patent Application Publication No. 20030067533, published on Apr. 10, 2003, the entire contents of which are hereby incorporated by reference. After the adjustment, the CPU 320 instructs the adjuster 112 of each of the optical writing devices 41Y, 41C, 41M, and 41K to obtain the counted scan time period for each of the colors.

Numerous additional modifications and variations are possible in light of the above teachings. It is therefore to be understood that within the scope of the appended claims, the disclosure of this patent specification may be practiced in ways other than those specifically described herein.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

1. An optical writing device, comprising:
a light source configured to irradiate a light beam;
a scanning device configured to scan the light beam to a first detection area and an image writing area of the optical writing device;
a first detector provided in the first detection area and configured to output a first detection signal at a first time when the light beam enters the first detection area;
a timing controller configured to output an image writing start signal at a second time which occurs after the first time; and
a light source controller configured to cause the light source to irradiate the light beam having a first fixed intensity at the first time, and to cause the light source to irradiate the light beam having a varied intensity after the second time.

2. The device of claim 1, further comprising:
a second detector provided in a second detection area and configured to output a second detection signal at a third time when the light beam enters the second detection area,
wherein the light source controller is further configured to cause the light source to irradiate the light beam to have a second fixed intensity at the third time.

3. The device of claim 2, wherein the first fixed intensity and the second fixed intensity are substantially equal to each other.

4. The device of claim 2, further comprising:
an adjuster configured to obtain a difference value between the first time and the third time based on the first detection signal and the second detection signal; and
a pixel clock generator configured to adjust a clock signal using the difference value to generate an adjusted clock signal,
wherein the light beam is irradiated in synchronization with the adjusted clock signal.

5. The device of claim 2, wherein the light source controller comprises:
a light source driver configured to control at least one of the first fixed intensity, the varied intensity, and the second fixed intensity of the light beam based on a reference voltage.

6. The device of claim 1, wherein the image writing area is classified into a plurality of areas based on optical characteristics of the optical writing device.

7. The device of claim 2, wherein the first fixed intensity is determined based on optical characteristics of the first detector, and the second fixed intensity is determined based on optical characteristics of the second detector.

8. The device of claim 2, wherein the light source controller is configured to turn on a shading correction function after the second time.

9. The device of claim 8, wherein the light source controller is configured to turn off the shading correction function before the third time.

10. An optical writing device, comprising:
means for scanning a light beam to a first detection area, and an image writing area of the optical writing device;
means for determining whether optical writing device is irradiating a first detection area or the image writing area and generating a determination result; and
means for controlling an intensity of the light beam to be a first fixed intensity when the determination result indicates that the light beam irradiates the first detection area, and to be a varied intensity when the detection result indicates that the light beam irradiates the image writing area.

11. The device of claim 10, wherein the controlling means is further configured to control the intensity of the light beam to be a second fixed intensity when the determination result indicates that the light beam irradiates a second detection area.

12. An image forming apparatus, comprising:
an image reader configured to read an original document into image data;
an optical writing device configured to form a latent image on an image writing area of an image carrier according to the image data by irradiating a light beam; and
a controller configured to set an intensity of the light beam to be a first fixed intensity when the light beam irradiates a first detection area provided outside of the image writing area, and to set the intensity of the light beam to be a varied intensity when the light beam irradiates the image writing area.

13. The apparatus of claim 12, wherein the controller is further configured to set the intensity of the light beam to be a second fixed intensity when the light beam irradiates a second detection area provided outside of the image writing area.

14. The apparatus of claim 13, wherein the optical writing device is further configured to count a time period from a timing when the light beam enters the first detection area to a timing when the light beam enters the second detection area.

15. The apparatus of claim 14, wherein a counted time period is obtained after the controller instructs the optical writing device to start an image writing operation.

16. The apparatus of claim 15, wherein the controller is further configured to perform magnification correction based on the counted time period.

17. The apparatus of claim 14, further comprising:
a pattern detector configured to detect a pattern, which is formed on an area outside of the image writing area of the image carrier after the latent image is formed on the image writing area of the image carrier,
wherein the controller is further configured to perform magnification correction based on the detected pattern.

18. A method for controlling an optical writing device which irradiates a light beam, comprising:
determining an area to which the light beam irradiates, the area comprising a first detection area, an image writing area, and a second detection area to generate a determination result; and
driving the optical writing device with a reference voltage, wherein the reference voltage is set to be a first fixed intensity when the determination result indicates that the light beam irradiates the first detection area, to be a varied intensity when the determination result indicates that the light beam irradiates the image writing area, and to be a second fixed intensity when the determination result indicates that the light beam irradiates the second detection area.

19. The method of claim 18, wherein at least one of the first fixed intensity, the varied intensity, and the second fixed intensity are stored in a corresponding manner.

20. The method of claim 19, wherein the varied intensity is set based on image forming conditions.
